(19) United States
(12) Patent Application Publication
(10) Pub. No.: US 2011/0240783 A1
(43) Pub. Date: Oct. 6, 2011

(54) METHOD AND ARRANGEMENT FOR IMPROVING THE FIXING ARRANGEMENT OF A CHIPPER BLADE

(75) Inventors: Pekka Kokko, Hollola (FI); Kari Jääskeläinen, Kauhajoki (FI)

(73) Assignee: ANDRITZ OY, Helsinki (FI)

(21) Appl. No.: 13/133,045

(22) PCT Filed: Dec. 7, 2009
(86) PCT No.: PCT/FI2009/050984

§ 371 Date: Jun. 6, 2011

(30) Foreign Application Priority Data
Dec. 5, 2008 (FI) 20086172

(51) Int. Cl. B02C 7/12; B21D 39/03

(52) U.S. Cl. 241/291; 29/428

(57) ABSTRACT

A fixing arrangement of a chipper blade for a chipper having a cylindrical blade disc, one end surface of which is provided with one or more blades extending essentially radially in relation to the blade disc and for support thereof a wearing segment is arranged, the chipper is provided with a wearing surface subsequent the blade for resisting the stress caused by the logs being chipped in the chipper. At least one blade segment is arranged to be supported onto the blade and the wearing segment, an upper surface of which forms a desired portion of the wearing surface, and a coating is formed on the upper surface to resist stress.

### OBJECT OF THE INVENTION

The invention relates to a method of improving the fixing arrangement of a chipper blade, said chipper comprising an essentially cylindrical blade disc, one end surface of which is provided with one or more blades extending essentially radially in relation to the blade disc, and for support thereof a wearing segment is arranged, an upper surface of which is provided with a coating for resisting the stress caused by logs being chipped in the chipper. The invention also relates to an arrangement implementing the method.

### PRIOR ART

Wood chips used for the needs of the paper and pulp industry are commonly produced using a disc chipper. The chipper has a blade disc that is supported on bearings in the frame of the apparatus rotatably around its shaft, and a number of blades are adapted thereto slightly deviating from the direction of radius of the blade. The blades are arranged to pass the edge of the counter blade at a distance corresponding to the desired blade clearance as the blade disc rotates. When chipping wood, the blades of a blade disc hit the log being chipped, which log in its turn is supported on the opposite side onto a counter blade.

By means of a chipper, wood logs introduced therein are chipped to form wood chips of desired size for further treatment. During operation, the blade disc and parts thereof are exposed to strong stresses causing wearing, both mechanical and chemical, as well as other stresses. Especially this applies to the blade disc and parts arranged for fixing and supporting thereof. Use has conventionally been made of a so-called insert blade arrangement, whereby a blade disc inserted in a blade is supported especially in the radial direction with a wearing segment part. One, upper side of the blade and the upper side of the wearing segment part form a continuous surface or plane, or at least a major part thereof, in a way determined for each specific case. This surface extends to the subsequent blade opening. In this patent application, the surface intermediate the blade and the subsequent blade opening in the direction of passing of the wood is generally referred to as wearing surface. Wood, generally a log, cut by the blade usually passes the arrangement on this wearing surface side and passes further towards the next blade. The wearing segment part is formed of one massive piece manufactured of a base material, typically of constructional steel of high strength.

For hardening the upper surface of the wearing segment part and for increasing the wearing resistance thereof, a hard coating is surface-sprayed thereon. Forming of this kind of prior art wearing coating has required sintering. Thereby the coating is formed on the surface of the base material by increasing the temperature of the base material to a range of approximately 1000° C. Typically the heating is performed in a stove.

However, this method leads to several disadvantages in view of the base material of the component being treated. Firstly, the base material softens as a result of sintering. A resulting disadvantage is that the material becomes less resistant to loading and thus does not support the blade as desired. Deficient strength properties of the wearing segment part are to be compensated by massive and thus space-consuming dimensioning of the wearing segment. The mass of the wearing segment part is typically in the range of 200 kg. Also, the wearing resistance of the wearing segment part is deficient. Further, due to strength properties, the blade itself must sometimes be formed unnecessarily thick.

A further remarkable disadvantage is that when this kind of large piece is sintered, its dimensions are inevitably altered—buckling is a typical phenomenon. Deformations of a piece taking place in connection with sintering most usually require re-machining after performing the coating. This causes both additional requirements for the production technique and increases the production costs. Similarly, the adaptation of the piece itself and its dimensions in the object of application becomes remarkably more complicated, when simultaneously taking into account the dimension tolerances set for the parts of the apparatus and their mutual locations.

The deformations caused by sintering have an adverse effect on the final thickness of the actual coating, especially on the uniformity thereof. Deformations cause altering in the thickness of the coating, as re-machining of the coated surface is not possible after sintering. The thickness of the coating is typically in the range of 1 mm, so that the tolerance of the thickness of the coating is very small.

Further, allowance for machining is to be left on other surfaces of the sintered piece, so that the location of the coating in the apparatus can be arranged to the right place by adequate machining. This kind of adaptation and dimensioning renders the manufacture complicated and requires accuracy in order to get the coated wearing surface to exactly the right level and in the right direction.

In addition to the above-mentioned stove heating, during sintering the area to be coated can also be heated by means of flames. While stove heating produces more uniform heating on one hand, but decreased material properties on the other hand, flame heating allows focusing the heat more precisely to the area to be coated, but with the simultaneous disadvantage of increased buckling of the piece due to non-uniform, mainly unilateral exposure to heat and thus unilateral heat distribution, and the resulting problems of the kind that were discussed in the above.

Attempts have been made to solve these problems by using an arrangement, where the blade is supported by a supporting piece arranged behind the blade, mostly a plate-like support piece, with good strength properties. Thus, requirements set for the material of the actual wearing segment part can be reduced, as the supporting piece offers the blade increased counter support against stress forces caused by logs, mainly in their direction of travel.

Additionally, the surface of the wearing segment, in the logs' travel direction after the supporting piece, is provided with a wearing-resistant coating, mostly by the above mentioned sintering method. This arrangement, however, has the deficiency that the edge of the coating located towards the blade has to be left at a certain distance from the blade and the supporting piece. This is because the coating would otherwise not withstand without breaking the slight elastic motion of the blade accompanying the loading, which takes place in the wearing segment in the area of its jut-like edge located against the supporting piece. The supporting piece itself wears as well, because it can not be provided with a coating against wearing by means of sintering.

This results to a further problem, i.e. this uncoated strip and the supporting piece begin to wear during operation and form a “hole” in the wearing segment between the blade and the coating. In time, the edge of the coating itself is completely exposed to wearing stress and the adhesion the edge of the coating decreases and the coating will finally start flaking off the base material.

### The Function and Solution of the Invention

The aim of the invention is to provide a solution allowing decreasing or totally avoiding above-mentioned problems of prior art. A function of the present invention is to give a solution to the above-mentioned problems, by means of which the wearing surface subsequent to the blade is made to resist the stresses it is exposed to. To solve this task, a method is disclosed that is characterized in what is presented in the characterizing part of claim 1. The characteristic features of the method implementing the arrangement of the invention are in their turn disclosed in the characterizing part of claim 6. Additionally, some preferred embodiments of the invention become known from the dependent claims.

A central idea of the invention is to provide an operative supporting arrangement for the blade, which supporting arrangement simultaneously resists the wearing effect of logs. Good and solid support allows making the blade thinner, and with reduced costs. At the same time, the supporting means are arranged so that a good wearing resistance of the wearing surface of the supporting means is obtained without the above-described adverse effects on the properties of the base material. Simultaneously the aim is a simple and inexpensive construction of the rest of the wearing segment part.

The basic solution according to the invention utilizes a module-type of arrangement, where the wearing segment is still formed of a massive basic element. Unlike earlier, a corrosion-resistant and strong part separate from the wearing segment is here arranged behind the blade to support the blade, which part is here referred to as blade segment. This element arranged directly behind the blade to support it is beam-like, with e.g. trapezoidal cross-section, such as in FIG. 3. The blade segment is arranged to support the blade while it itself is supported either directly or via an intermediate piece onto the wearing segment part or the blade disc. The cross-section of the blade segment preferably decreases to a desired extent towards the central axis of the blade disc. Thus, when viewed in the axial direction of the blade disc, the form thereof is more or less sector-like. On the other hand, it is also possible to use equal size dimensioning for the cross-section. In that case the cross section remains essentially constant at the whole length of the blade segment, i.e. in its extension in the direction of the blade disc's radius. The production of this kind of beam-like element, as well as the wearing segment, is simultaneously made

As to the coating, the HVOF-method (High Velocity Oxygen Fuel Spray) can be applied according to a preferred embodiment of the invention, in which the coating is applied on the surface of the basic material by means of high velocity spraying. The basic element does not have to be heated, which allows avoiding the above described detrimental effects caused by the sintering method. A well adhesive, durable coating is obtained having uniform thickness and being immediately ready. In this application, coating refers to both the coating applied on the surface basic material's surface by an appropriate method and the surface structure obtained by an appropriate method and having properties different than those of the basic material.

### Advantages Obtained with the Invention

By utilizing a blade segment according to the invention, which is preferably located in the area of the upper part of the blade between the wearing segment and the blade and simultaneously forms a part of the earlier total volume of the wearing segment, several advantages are gained. As the support arranged in the area of the upper part of the blade plays the biggest role, it is adequate that the element used for support just in that area has especially good strength properties. It is just in this area where the support for the blade is arranged by means of the blade segment. In the lower part, instead, the properties of a conventional wearing segment are adequate, so that no special requirements are set for the other areas of the wearing segment. Thus, the blade segment does not have to extend up to the blade disc.

The surface construction or coating of the upper surface of the blade segment acting against wearing can still be made preferably of carbide. As an example, tungsten carbide or chromium carbide can be mentioned, however, without any limitation to these alternatives. According to a highly preferable embodiment of the invention, the coating may thus be formed using the so-called High Velocity Oxygen Fuel Spray-method, i.e. HVOF-method. It utilizes a very high feeding speed (even 1200 m/s) of the coating particles. The result is a coating that is well attached to the base material, is wear-resistant and immediately ready.

It has now been noticed that such a coating is especially suitable for the wearing surface of a chipper, where it is exposed to remarkably high wearing stress. By implementing the HVOF-method according to the invention for a chipper, a thin and highly wear-resistant coating is obtained, which does not need any further treatment. This facilitates the production of the apparatus remarkably and decreases the production costs. Simultaneously the overall construction of the fixing arrangement is rendered considerably simpler than earlier and with more economical expenses.

### LIST OF FIGURES

In the following, the invention is disclosed in more detail with reference to the appended figures, of which

FIG. 1 illustrates as a partial cutaway view the fixing arrangement of a prior art disc chipper blade,

FIG. 2 illustrates similarly to FIG. 1 an improved arrangement of another prior art disc chipper blade and counter blade,

FIG. 3 illustrates similarly to FIG. 1 as a partial cutaway view an arrangement of a blade and counter blade in accordance with the present invention.

FIG. 4 illustrates a highly preferable embodiment according to the invention.

### DETAILED DESCRIPTION OF THE INVENTION

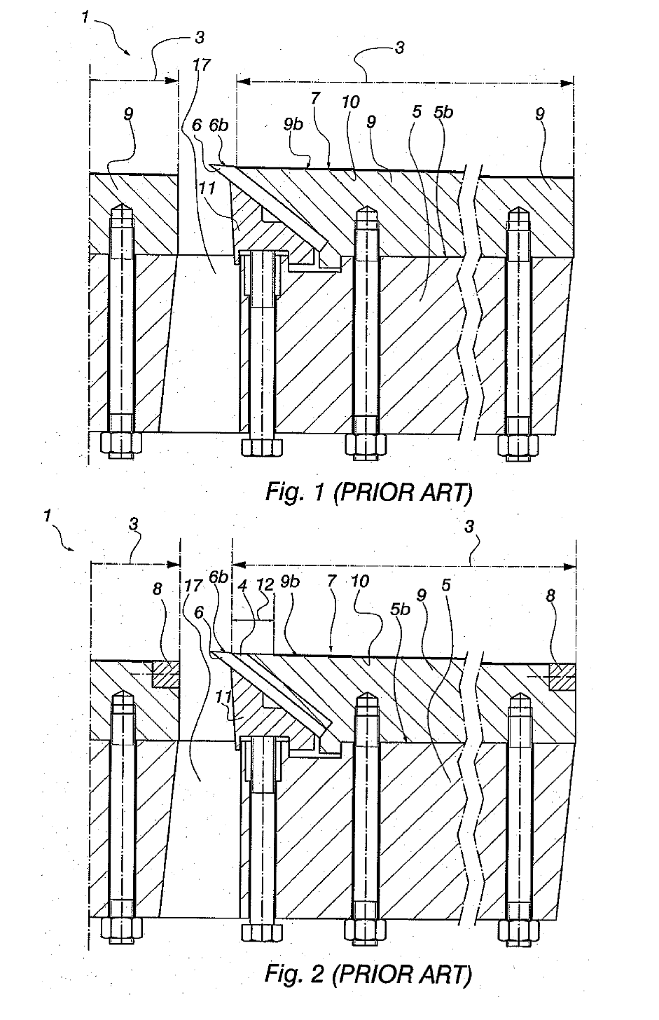

FIG. 1 illustrates as an essentially tangential cutaway view a detail of a disc chipper 1 used for producing wood chips. The chipper 1 has a blade disc 5 that is arranged in the chipper frame (not shown) for rotating around its shaft. The wood is chipped by means of blades 6, usually adapted to the blade 5 slightly deviating from the direction of the radius, of which blades only one is illustrated in FIG. 1. Traditionally, in the fixing of a blade use has been made of a so-called insert blade arrangement, where a blade 6 inserted in a blade disc is supported especially in radial direction by a wearing segment part 9 arranged in the blade disc 5 against its end surface 5b either directly or indirectly into contact therewith, and from the front side by a blade holder 11.

The blades 6 are arranged to pass the edge of the counter blade (not shown) at a distance corresponding to the desired blade clearance as the blade disc rotates. The blades 6 bite the log being chipped, which on its opposite side is supported onto the counter blade. The chips produced by the blade are passed via a blade opening through the blade disc and further to the outlet (not shown) of the chipper. The log in its turn proceeds further and towards the following blade. Simultaneously it touches a usually essentially continuous surface or plane 7 formed by the other side 6b of the blade 6 and the outer surface 9b of the wearing segment part. The part of the surface 7 following the blade 6, the wearing surface 3, is during operation exposed to hard wearing stress and thus requires a solid and wear-resistant implementation. Thus, here the wearing surface 3 refers to an area following the blade 6, which are is exposed to the logs. Usually at least a major part of this surface is formed of the upper surface 9b of the wearing segment 9. So, the wearing surface 3 extends between the blade 6 and the blade opening 17 ending to the latter.

The wearing segment part 9 of the chipper is formed of one massive piece manufactured of a base material, typically of constructional steel of high strength. This kind of material does not stand the hard wearing stress caused by the logs, and thus a hard coating 10 is sprayed on the surface of the wearing segment part for hardening thereof, which coating is stove-sintered. The thickness of the coating 10 is exaggerated in the figures for clarity.

However, the gained wearing resistance is limited. Further, due to reasons specified in the above, the strength properties of the wearing segment part are weakened. For e.g. this reason, the blade itself has to be formed thick in order to achieve the required strength. A disadvantage of this arrangement is also the great weight (typically approximately 200 kg) of the wearing segment part.

FIG. 2 illustrates another prior art solution, which utilizes a support element 4 for supporting the blade. Thereby, the blade itself can be left thinner than earlier. The wearing segment is further comprised of a massive wearing segment part 9.

Right after the support element 4 a further wearing-resistant carbide layer is formed. The thickness is typically less than 1 mm. Though the carbide coating provides a very wearing-resistant surface, the above mentioned wearing problems still remain, especially in the area 12 between the coating and the support element and in the support element 4 itself. Due to the reason specified in the above, the unprotected band 12 has to be left far too large in view of durability, typically over 15 mm. Therefore, the wearing effect of the logs can have detrimental effects in the area. A further disadvantage is the fluctuation of the thickness of the coating 10 caused by deformations and adaptation.

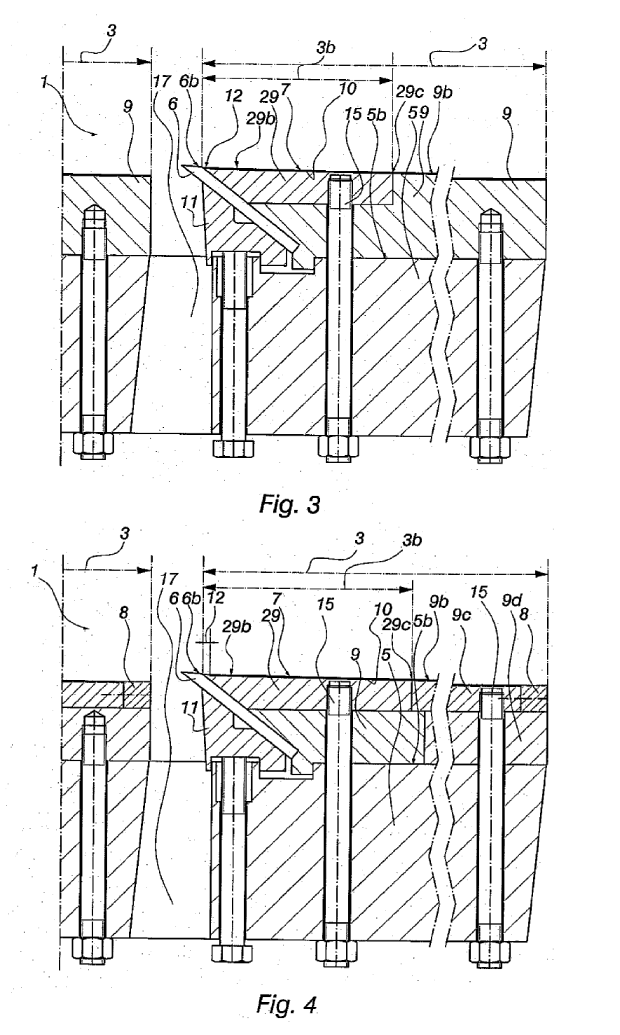

FIG. 3 instead illustrates a basic solution according to the invention. It is also illustrated as an essentially tangential partial cutaway view of blade disc 5. The actual wearing segment is still formed of a massive wearing segment part 9 forming the basic frame, which is arranged against the end surface 5b of the blade disc 5. Also the front side of the blade is provided with an appropriate blade holder 11 for supporting the blade 6 on the other side. Firstly, a corrosion-resistant and strong blade segment 29 is provided between the segment part 9 and the blade 6 to support the blade. It can be made of e.g. high-alloy, strong corrosion-resistant material.

According to a basic idea of the invention, wearing-resistant surface construction or coating, which preferably is a carbide layer 10, is arranged on the upper surface 29b of the blade segment 29. The coating of the blade segment thus forms a part 3b of the wearing surface 3. The width of the blade segment—thus, here corresponding to 3b—and, accordingly the portion of the total width 3 of the wearing surface 3 can be chosen as desired. It can be e.g. less than half of the extent of the wearing surface in the direction of tangent of the blade disc's radius, i.e. in the circumferential direction. More precisely, it is the extension in the direction of travel of the logs. Preferably said width is between 50-1000 mm, most suitably between 100-500 mm. Naturally, this width of the blade segment changes along the radius of the blade disc, when the blade segment has a sector-like shape.

Especially preferably the coating 10 is formed by the HVOF-method. This coating alone and without any other finishing is adequate to form a durable protection against the wearing stress caused by the logs. The advantage is now that the band 12 remaining between the coating 10 and the blade 6 can be arranged very narrow, e.g. in the range of 5 mm. Similar to FIG. 2, the size of the band 12 is strongly exaggerated for clarity. Just by the blade the wearing effect is still very small, especially if the upper surface 6b of the blade is arranged slightly higher than the coating 10, e.g. with a difference in the range of 0.5 mm. At the leaving edge 29c of the blade segment's surface 29b the coating may, instead, be arranged to extend up to the edge.

Simultaneously a simple and low-cost construction of the fixing arrangement for the blade and other parts of the wearing segment is obtained, i.a. without a need for re-machining and adapting after the coating.

The fixing arrangement for the blade segment 29 preferably comprises fixing bolts 15 or corresponding fixing means. They can be arranged to extend through the blade disc 5 to the blade segment 29. By means of those, the blade segment can be arranged to be fixed to the basis part 5 of the blade disc. Also, the blade segment is naturally supported onto the actual wearing segment 9. Welding joints can also be used for fixing the blade segment 29, which now are easily arranged between the blade segment and the blade disc, as well as between the blade segment and the wearing segment, protected against wearing effect. Also, a robust joint between the blade segment and the wearing segment 9 or the blade disc 5 is possible, as well as other prior art fixing methods or combinations thereof.

As to the wearing segment 9, according to still another embodiment of the invention, two or more parts can be used. FIG. 4 illustrates a wearing segment comprised of parts 9, 9c and 9d. Thus, the wearing segment unit can be made of both superposed and successive parts or combinations thereof. The upper surface 9b of the wearing segment can thus still be treated in order to increase its wearing resistance. By assembling the wearing segment this way modularly, the wearing segment part that forms the upper surface 9b can be replaced when the coating in time wears without needing to replace the whole wearing segment. Similarly, the parts of the blade segment located against the blade disc 5 and the parts of the wearing segment forming the upper surface 9b can also be made of different materials as required.

Accordingly, the blade segment can also be formed of one piece or of several parts. The blade segment can e.g. in the longitudinal direction of the blade be formed of two or three successive pieces of equal or different size. It is even possible to arrange pieces similar to the blade segment both in view of other properties and coating 10 in the whole area of the wearing surface 3, whereby the wearing segment 9 remains between the blade segment 29 and the blade disc 5.

1.-10. (canceled)

11. A chipper comprising:
a substantially cylindrical blade disc;
a cutting blade attached to the disc and extending in a length direction generally radially with respect to a rotational axis of the blade disc, wherein the cutting blade extends outward in an axial direction from an end surface of the blade disc;
a wearing segment adjacent the blade and fixed to the end surface of the blade disc,
a wearing surface of the wearing segment, wherein the wearing surface is adjacent the blade;
a blade segment adjacent the blade and fixed with respect to the wearing segment, an outer surface of the blade segment is in the same plane as the wearing surface, and
a wear resistant coating on the outer surface of the blade segment.

12. The chipper of claim 11 wherein said coating is formed by a high velocity oxygen fuel spray.

13. The chipper of claim 12 wherein the coating includes a carbide coating.

14. The chipper of claim 13 wherein the blade segment is fixed to the blade disc by at least one of a bolt, and a weld between the blade segment and the blade.

15. A chipper comprising:
an substantially cylindrical blade disc, wherein an end surface of the disc supports blades extending outward in an axial direction from the blade disc,
a wearing segment attached to the end surface of the blade disc, wherein the wearing surface is adjacent the blade and includes a wearing surface parallel to the end surface of the disc;
a blade segment adjacent the blade, extending over a portion of the wearing segment and fixed to the blade disc;
an upper surface of the blade segment is between the upper surface is in a plane with the wearing surface and is between the blade and the wearing surface of the wearing segment;
a coating on the upper surface provides a wear resistant coating to the upper surface.

16. A chipper according to claim 15 wherein said coating is formed by a high velocity oxygen fuel spray.

17. A chipper according to claim 15 wherein the coating includes a carbide layer.

18. A chipper according to claim 15 wherein the blade segment is fixed to the blade disc by at least one of bolts extending through the blade and a weld.

19. A method to assemble blades on a chipper comprising:
attaching a cutting blade to a blade disc having an end surface which rotates about an axis, wherein the length of the attached cutting blade is oriented in a radial direction with respect to the blade disc and the cutting blade extends forward of the end surface;
positioning a wearing segment on the end surface and affixing the wearing segment to the blade disc, wherein the wearing segment is positioned to abut against the cutting blade;
fixing a blade segment to the end surface of the blade disc such that a side surface of the blade segment abuts the blade and a forward surface of the blade segment is between the blade and a forward surface of the wearing segment, wherein the upper surface and the wearing surface are in the same plane, and
applying a wear coating to the upper surface of the blade segment.

20. The method of claim 19 wherein the wear coating is applied by a high velocity oxygen fuel spray.

21. The method of claim 19 wherein the applied coating includes a carbide layer.

22. The method of claim 19 wherein the blade segment is fixed to the blade disc by at least one of bolts extending through the blade and a weld.

23. the method of claim 19 wherein the blade segment positioned over a portion of the wear segment, and the portion of the wear segment is sandwiched between the blade segment and the end surface.
